(19) United States
(12) Patent Application Publication
(10) Pub. No.: US 2025/0332945 A1
(43) Pub. Date: Oct. 30, 2025

(54) SYSTEMS AND METHODS TO ONBOARD ELECTRIC VEHICLE SUPPLY EQUIPMENT (EVSE)

(71) Applicant: PowerFlex Systems, LLC, San Diego, CA (US)

(72) Inventor: Ted LEE, San Marino, CA (US)

(21) Appl. No.: 19/189,867

(22) Filed: Apr. 25, 2025

Related U.S. Application Data
(60) Provisional application No. 63/640,809, filed on Apr. 30, 2024.

(51) Int. Cl. B60L 53/68; B60L 53/67; H04W 40/24

(52) U.S. Cl. CPC B60L 53/68; B60L 53/67; H04W 40/24

(57) ABSTRACT

Certain aspects of the present disclosure provide techniques for electrical vehicle charging management. In examples, techniques may include receiving one or more packets including a first request from a first electric vehicle supply equipment (EVSE) to connect to a central management system, wherein: the first request from the first EVSE includes a first identifier associated with the first EVSE, and the one or more packets further include an Internet Protocol (IP) address associated with a Uniform Resource Locator (URL); determining whether the first EVSE is allowed to connect to the central management system based on the first identifier; and sending first data related to the first request from the first EVSE to a staging service based on a determination that the first EVSE is not allowed to connect to the central management system based on the first identifier.

### CROSS-REFERENCE TO RELATED APPLICATIONS

This Application claims the benefit of and priority to U.S. Provisional Patent Application No. 63/640,809, filed on Apr. 30, 2024, the entire contents of which are hereby incorporated by reference.

### INTRODUCTION

Electric vehicle (EV) charging infrastructure is a rapidly growing field. EV charging stations often rely on backend systems (e.g., backend cloud systems) to manage charging sessions. For example, when an EV connects to an EV charging station, the EV charging station sends a status update to a backend system which then initiates and manages a charging session. The backend system maintains databases of active charging sessions across multiple sites and sends charging parameters down to individual EV charging stations. This centralized approach enables system-wide optimization and advanced features, but requires that the EV charging stations be “known,” such that only the known (e.g., registered or trusted) EV charging stations are served via the resources available from the backend systems.

To register or onboard EV charging stations (e.g., “unknown” EV charging stations) can lead to several issues. For example, when a large number of EV charging stations (e.g., those bought directly by a new customer or those that are existing EV charging stations which previously received charging services from a different charging service provider) need to be set up to be able to make a secure connection to a given backend system providing charging services, a great amount of resources can be required. As but one example, it may be a very costly effort to manually connect to individual EV charging stations to verify their identifiers and manually update one or more settings on each EV charging station individually to enable the EV charging stations to connect to the backend system of a new charging service provider. Such onboarding process takes a large amount of resources, and it can lead to an undesired delay in the EV charging stations being onboarded, potentially resulting in even an unwanted interruption in service of the EV charging stations. As the EV charging infrastructure continues to expand, these problems are expected to become more pronounced.

### SUMMARY

In accordance with embodiments of the present disclosure, a processing system is provided for managing electric vehicle charging. The processing system includes one or more memories and one or more processors coupled to the one or more memories. The one or more processors may be configured to cause the processing system to: receive one or more packets including a first request from a first electric vehicle supply equipment (EVSE) to connect to a central management system, wherein: the first request from the first EVSE includes a first identifier associated with the first EVSE, and the one or more packets further include an Internet Protocol (IP) address associated with a Uniform Resource Locator (URL); determine whether the first EVSE is allowed to connect to the central management system based on the first identifier; and send first data related to the first request from the first EVSE to a staging service based on a determination that the first EVSE is not allowed to connect to the central management system based on the first identifier.

In accordance with embodiments of the present disclosure, a method is provided for managing electric vehicle charging. The method may include: receiving one or more packets including a first request from a first EVSE to connect to a central management system, wherein: the first request from the first EVSE includes a first identifier associated with the first EVSE, and the one or more packets further include an IP address associated with a URL; determining whether the first EVSE is allowed to connect to the central management system based on the first identifier; and sending first data related to the first request from the first EVSE to a staging service based on determining that the first EVSE is not allowed to connect to the central management system based on the first identifier.

In accordance with embodiments of the present disclosure, a system is provided for managing electric vehicle charging. The system may include a staging service device and an onboard gateway device in data communication with the staging service device. The staging service device may include one or more processors configured to: authorize a first identifier associated with a first EVSE. The onboard gateway device may include one or more processors configured to: receive one or more packets including a first request from the first EVSE to connect to a central management system, wherein: the first request from the first EVSE includes the first identifier associated with the first EVSE, and the one or more packets further include an IP address associated with a URL; determine whether the first EVSE is allowed to connect to the central management system based on the first identifier; and send first data related to the first request from the first EVSE to the staging service device based on a determination that the first EVSE is not allowed to connect to the central management system based on the first identifier.

Other embodiments of the present disclosure may provide non-transitory, computer-readable media comprising instructions that, when executed by one or more processors of one or more processing systems, cause the one or more processing systems to perform the aforementioned methods as well as those further described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for managing electric vehicle charging, according to embodiments provided herein;

FIG. 2 depicts a software configuration for an edge environment for managing electric vehicle charging, according to embodiments provided herein;

FIGS. 3A-3C depict device configurations for an edge environment for managing electric vehicle charging, according to embodiments provided herein;

FIGS. 4A-4C depict hardware that may be utilized for the devices from FIGS. 3A-3C, according to embodiments provided herein;

FIG. 5 depicts a device configuration for a cloud environment for managing electric vehicle charging, according to embodiments provided herein;

FIG. 6 depicts a device configuration for an onboard system for managing electric vehicle charging, according to embodiments provided herein;

FIG. 7 depicts internal architecture and logic included within an onboard gateway, according to embodiments provided herein;

FIG. 8 depicts internal architecture and logic included within a staging server, according to embodiments provided herein;

FIG. 9 depicts an example data structure for representing connection request parameters, according to embodiments provided herein;

FIG. 10 depicts an example protocol sequence diagram for representing communication between an electric vehicle supply equipment (EVSE) and a Domain Name Service (DNS), according to embodiments provided herein;

FIG. 11 depicts an example flowchart illustrating a method for managing electric vehicle charging, according to embodiments provided herein; and

FIG. 12 depicts an example processing system for managing electric vehicle charging, according to embodiments provided herein.

### DETAILED DESCRIPTION

Embodiments disclosed herein include systems and methods for managing electric vehicle charging—for example, to onboard an electric vehicle supply equipment (EVSE) (also referred to herein as a charging station or an electric vehicle (EV) charging station) in order to enable a (e.g., secure) connection by the EVSE to a central management system. Some embodiments utilize an edge computing architecture that handles core charging station management functionalities on-site, allowing the onboarding to occur at a charging site. Furthermore, some embodiments utilize a backend system, such as, e.g., a cloud-based backend system, that handles core charging station management functionalities remotely, allowing the onboarding to occur remotely. Though certain examples may be discussed with respect to specific implementations, the techniques used herein may be used with any suitable central management system, such as on-site, cloud-based, or a combination thereof. The systems and methods for enabling EV charging infrastructure incorporating the same will be described in more detail, below.

Embodiments of the present disclosure may utilize an onboard gateway (or other similar system) for EV charging management, which may address potential issues related to a service delay or interruption when EVSEs are being onboarded for connection to a central management system. For example, use of techniques discussed herein for onboarding may eliminate the need for manually programming, or manually connecting to, individual EVSEs for the onboarding process. For example, in some embodiments, when a connection request is made from an unknown EVSE for the central management system, the onboard gateway, which can determine whether to promote or redirect the incoming connection to a secure service (e.g., of the central management system), can provide a service, where the incoming connections may first be routed to a staging service for onboarding the unknown EVSE. Once the unknown EVSE is onboarded, the connection requests from this EVSE may then subsequently be sent to the secure service. Accordingly, in certain embodiments, the onboard gateway allows a charging service management system (e.g., that includes a central management system) to function more robustly by bypassing the need to manually program individual EVSEs and by minimizing the potential service delay or interruption which may occur if an unknown EVSE needs to be onboarded manually for authorization for a secure service.

In various embodiments, the EVSEs may utilize a Uniform Resource Locator (URL) to connect to the onboard gateway (e.g., to connect to a central management system). Thus, certain embodiments disclosed herein may realize the technical benefit of allowing the specific address (e.g., Internet Protocol (IP) address) for reaching the central management system (including multiple devices or assets) to be flexible, enabling various features such as load balancing amongst the multiple devices or assets. Furthermore, in certain embodiments, this URL can be updated on the EVSEs as part of the onboarding process disclosed herein, where, in one example, the EVSEs can be updated to be served by different central management systems that can be reached via different URLs (e.g., from a cloud-based central management system to an on-site central management system, and vice versa) without requiring connecting to and updating individual EVSEs manually.

In certain embodiments, the techniques described herein may advance the field of EV charging infrastructure management by providing an onboard gateway that enables improved efficiency, optimization, and resiliency in connection management operations. By enabling the efficient onboarding of EVSEs, and in some cases the remote programming of various settings such as those for keys and/or the location of a charging service provider, the onboard gateway may onboard EVSEs in a more efficient and secure manner, and any service delay or interruption traditionally attributable to manual onboarding of EVSEs can be reduced. In this regard, in certain embodiments, even EVSEs with incorrect credentials may be able to connect to a staging service via the onboard gateway for onboarding. For example, the techniques described herein may allow such EVSEs with incorrect credentials to communicate with the staging service by allowing the EVSEs to connect to the staging service when the staging service is in a particular mode (e.g., “add” mode). In some cases, the EVSEs with incorrect credentials may be blocked from being able to connect to the staging service when the staging service is not in the particular mode (e.g., “add” mode). For example, a gateway service may be provided for accepting and/or denying connections from the EVSEs based on their information such as, for example, associated IP addresses. In certain embodiments, EVSEs may further be configured with different credentials at any time (e.g., with each EVSE having its unique set of credentials) for improved security.

Implementing efficient onboarding via an onboard gateway may provide capabilities not readily achievable with traditional central management systems of EV charging stations. In certain embodiments, an onboard gateway as disclosed herein is capable of receiving connection requests from both unknown and known EV charging stations and routing the connection requests to appropriate systems (e.g., the staging service or the (e.g., secure) central management system) to enable a seamless onboarding of the unknown EV charging stations. As additional functionalities to traditional EV charging system infrastructure, in certain embodiments, the techniques disclosed herein may provide technical improvements in onboarding of EV charging stations and availability of EV charging services.

### Example Computing Environment

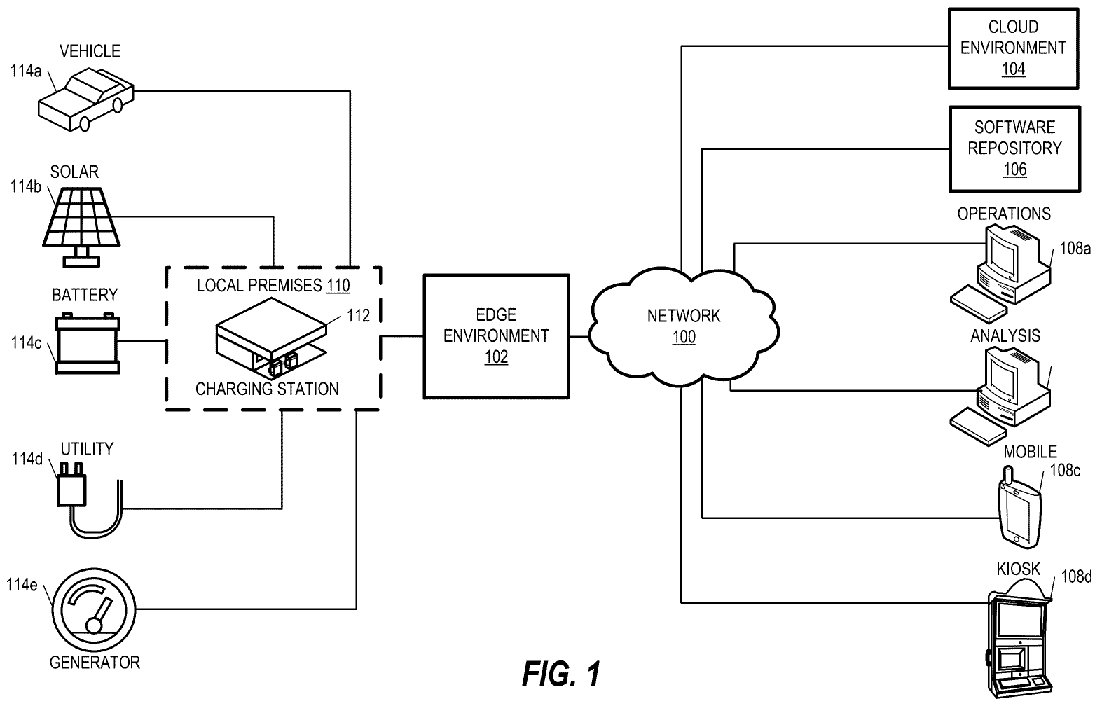

Referring now to the drawings, FIG. 1 depicts a computing environment for managing electric vehicle charging, according to embodiments provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

The edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as for charging of electric vehicles (e.g., EV 114a) using charging station 112. The charging station 112 may use one or more of various distributed energy resources (DERs), such as the solar device 114b, the BESS 114c, the utility grid 114d, and/or the generator 114e (e.g., an on-site diesel, natural gas, or other type of fueled generator). Generally, the aforementioned DERs may provide energy to the charging station 112 and/or use energy from the charging station 112 (e.g., by way of a backflow of energy from the EV 114a to other aspects of the site 110). In some embodiments, the charging station 112 may send excess energy back to the BESS 114c and/or to the utility grid 114d. Generally, the edge environment 102 may monitor and/or modify the energy sent to and received from the DERs to optimize various tasks, such as the charging of the EV 114a.

The charging station 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station refers to the power level and/or ability to provide electric power to a device being charged.

The edge environment 102 is configured as an interface between various aspects of the site 110 and the network 100. In various embodiments, compute resources for performing different functions at a site, such as control or optimization of EV charging, may be split between local compute resources in the edge environment 102 and remote compute resources, e.g., in the cloud environment 104 of FIG. 1

The cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

The software repository 106 is also coupled to the site 110 via the network 100. The software repository 106 may be configured as a platform to program, store, manage, and control changes, etc. to software that is implemented in the edge environment 102 and/or the cloud environment 104. In some embodiments, the software repository 106 may be configured as a proprietary service and/or may be provided by a third-party, such as GitHub™. Additionally, some embodiments may be configured such that the software repository 106 is provided by the same entity that manages the cloud environment 104. As such, these embodiments may be configured such that the software repository 106 and the cloud environment 104 may be combined.

With respect to the ancillary devices 108, the operations device 108a may be utilized to monitor and/or alter operations of the computing environment provided in FIG. 1 The analysis device 108b may analyze utilization, operation, charging, and/or other features of the computing environment provided in FIG. 1 The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some embodiments, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some embodiments may not be configured in this manner. Specifically, some embodiments may utilize a kiosk device 108d that is local at the site 110, which may communicate via a local network and/or the network 100 for providing the services described herein.

### Example Edge Environment

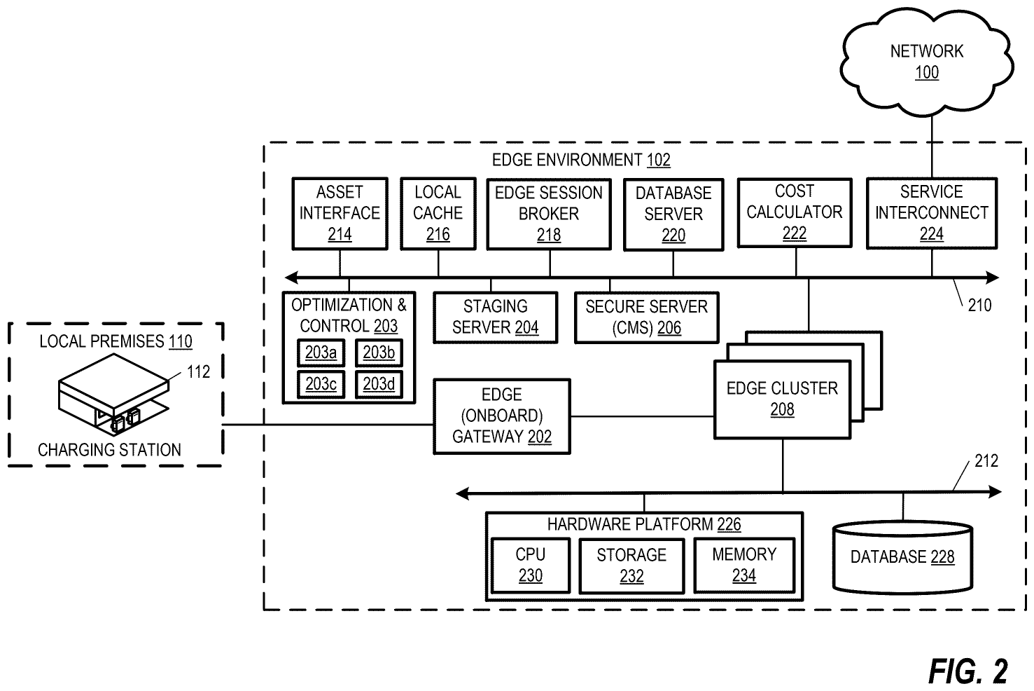

Referring now to FIG. 2 the edge environment 102 may be coupled to the site 110 via an edge gateway 202 (e.g., which may, at least in part, be configured as an onboard gateway in some embodiments as discussed herein). The edge environment 102 may be operatively coupled to various aspects of the site 110, such as the charging station 112 via the edge gateway 202. The edge environment 102 further includes an edge cluster 208, which is coupled to communication bus 210 and hardware bus 212. The communication bus 210 is coupled to optimization and control manager 203, asset interface 214, local cache 216, edge session broker 218, database server 220, cost calculator 222, and service interconnect 224 in this example. Moreover, the communication bus 210 is coupled to staging server 204 and secure server 206 (also referred to herein as central management system (CMS) 206 or secure central management system 206). The hardware bus 212 is coupled to hardware platform 226, which may include one or more processors, such as CPU 230, one or more storage components 232, one or more memory components 234, and/or other hardware components. Also coupled to the hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

The communication bus 210 and the hardware bus 212 may be utilized to facilitate operation of all services that run in the edge environment 102 and communicate with each other via a distributed message streaming system. The coupling of the aforementioned services may be accomplished in some embodiments via a distributed message streaming system, such as NATS.

In the depicted example, the charging station 112 is configured for communication with the edge environment 102 via the edge gateway 202, such as via a short-range wireless network technology, such as via a ZigBee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some embodiments, the edge gateway 202 may be configured to abstract data received from various aspects of the site 110 (of FIG. 1), such as the charging station 112, to remove protocol-specific distinctions. For example, a first charging station may utilize a first communication protocol and/or billing protocol and a second charging station may utilize a second communication protocol and/or billing protocol. The edge gateway 202 may receive data packets from both the first charging station using the first communication protocol and the second charging station using the second communication protocol. The edge gateway 202 may transform the received data into a protocol-agnostic format prior to providing the data to the edge cluster 208. This may allow wide interoperability between the edge environment 102 and various types of hardware (e.g., the charging station 112) at a site.

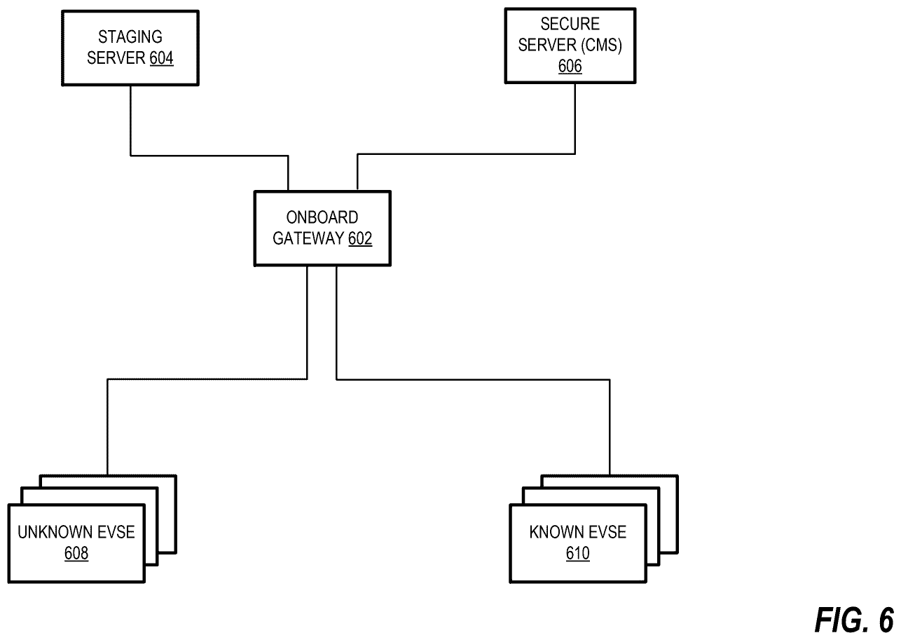

Furthermore, in various embodiments, the edge gateway 202 may be configured to provide an onboard service for unknown EVSEs to be onboarded, and may be an example of an onboard gateway. Details and example functionality of an onboard gateway, such as of the edge gateway 202, as well as the staging server 204 and the secure server 206, are described further herein, for example, with reference to, respectively, onboard gateway 602, staging server 604, and secure server 606 of FIG. 6 In the example illustrated in FIG. 2 the edge gateway 202, disposed in the edge environment 102, may provide onboard service as described further herein to local EVSEs such as the charging station 112 at the site 110.

The edge cluster 208 is the central message center in various embodiments. For example, when a user plugs a vehicle into the charging station 112, the edge cluster 208 receives data from the edge gateway 202, parses that data (e.g., to generate access state data) and causes the state data to be sent to the database server 220. The edge cluster 208 also receives the data and creates a session entry, which may be stored in the local cache 216. The edge cluster 208 may additionally send the session entry to the cloud environment 104 (of FIG. 1) via the network 100. The edge session broker 218 may also receive data related to the new session and may query the database server 220 to access additional session data to determine charging characteristics for the charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

The edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, the mobile device 108c does not need to access the edge environment 102 directly. Instead, the mobile device 108c may connect with the cloud environment 104 (of FIG. 1), which sends a message to the edge cluster 208 with an instruction to claim the session. The service interconnect 224 is configured for establishing an HTTP, TCP, and/or other type of communication with the cloud environment 104 (of FIG. 1) via the network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. In certain embodiments, the optimization and control manager 203 may include a database layer 203a to store data related to site configurations, an orchestration layer 203b to gather data and trigger optimizations, an optimization layer 203c to calculate set-points, and a control layer 203d for higher frequency feedback based controls. In some embodiments, the functionalities of the optimization and control manager 203 may be implemented, at least in part, within the cloud environment 104 (of FIG. 1).

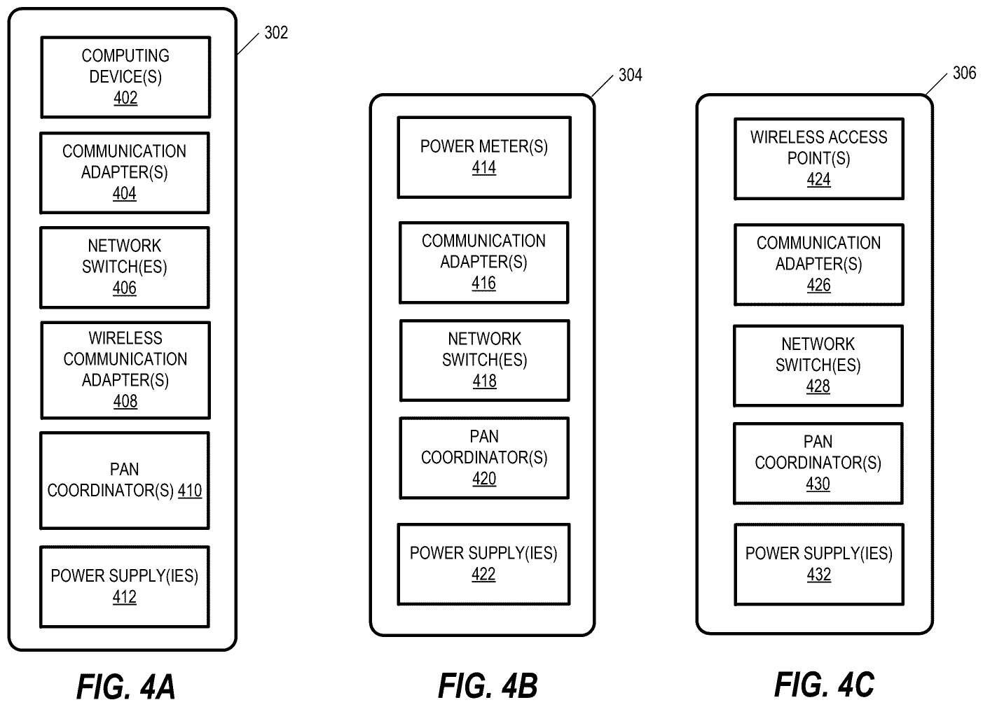

The hardware platform 226 represents any hardware for facilitating the processes and actions described herein. Specifically, the one or more CPUs 230 may represent one or more types of processing device configured for executing instructions. The one or more storage components 232 may be configured as long term storage, such as a hard drive or the like. The one or more memory components 234 may include any of various types of read or access memory or the like. The one or more databases 228 may be configured for additional storage and may be housed with the other hardware and/or elsewhere. Examples of different hardware platforms that may be deployed in the edge environment 102 are described further below with respect to FIGS. 4A-4C.

### Hardware Configurations for Edge Environment

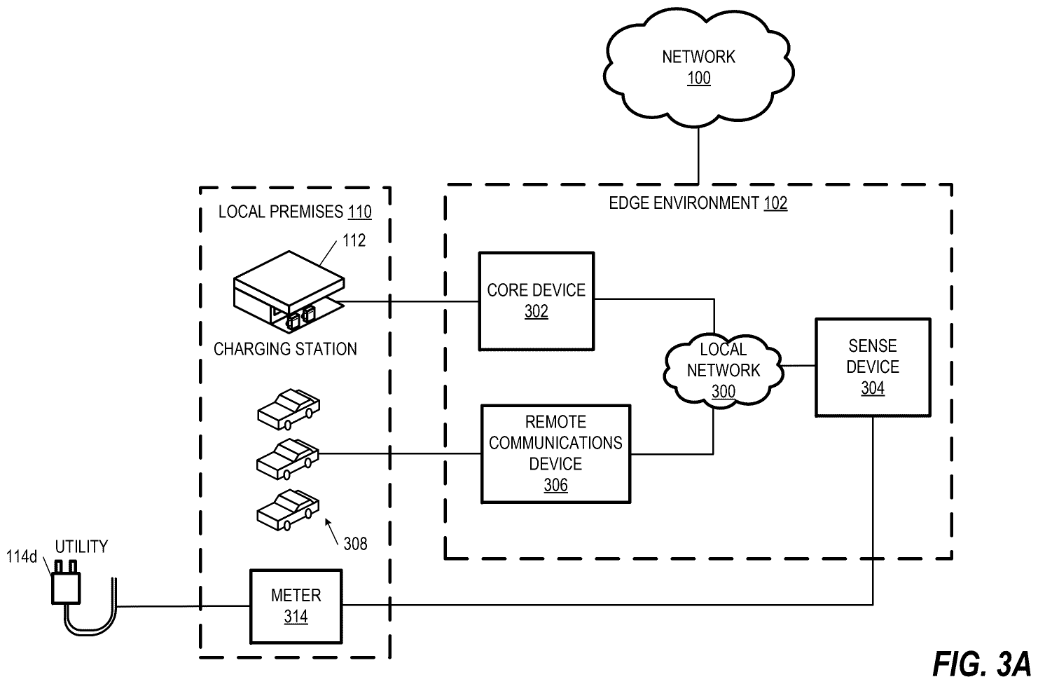

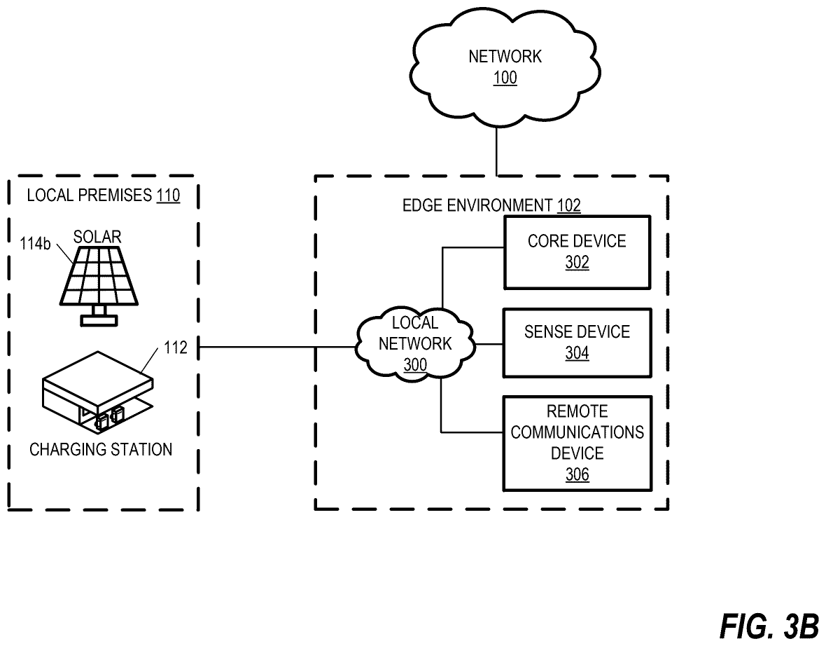

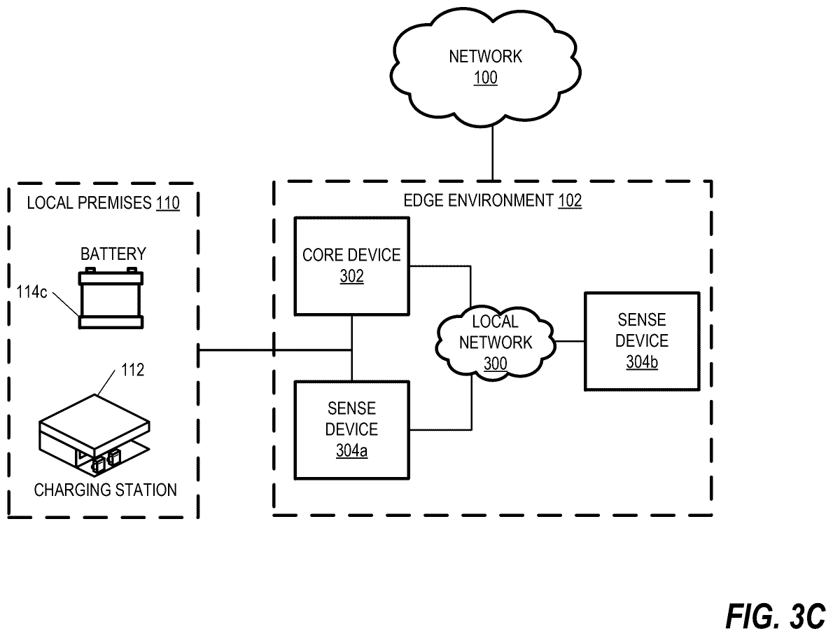

FIGS. 3A-3C depict device configurations for edge environment for managing electric vehicle charging, according to embodiments provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of the one or more chargers in the charging station 112. A sense device 304 may be installed, for example, in an electrical room or in another enclosure with electrical equipment of the charging station 112 and/or the one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as at a sub-level of a parking garage, one or more remote communications devices 306 are included as required. Also included at the site 110 is a meter 314 for communicating energy with the utility grid 114d.

The core device 302 shown in FIG. 3A is the central processing device and serves as the communications hub. In certain embodiments, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set points for the charging stations 112 and/or other assets, such as via an optimization algorithm that may be stored locally and/or at the cloud environment 104. It will be understood, however, that some embodiments may be configured such that the core device 302 performs optimization locally. In certain embodiments, the core device 302 dispatches these set points through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single-and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communication devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to embodiments provided herein. Specifically, FIG. 4A depicts hardware components that may be present in the core device 302. In some embodiments, the core device 302 is the brain where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some embodiments, the computing device(s) 402 may include power line communication (PLC) infrastructure, while some embodiments may utilize retail and/or micro-industrial computer components for optimization, load management, communication coordination, and/or historian services.

The communication adapter(s) 404 may be configured for load balancing and otherwise managing communications of, for example, Modubus RTU (RS485) to Modbus TCP (ethernet) or Ethernet IP (RJ 45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a ZigBee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain embodiments may be optimized for ease of installation and reduced intrusion to the site. Power over Ethernet (PoE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more power meters 414, one or more communication adapters 416, one or more network switches 418, one or more PAN coordinators 420, and/or one or more power supplies 422. The power supply(ies) 422 may include a power interface for providing power to the sense device 304. The power meter(s) 414 may be utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via ZigBee, Bluetooth, and the like. In some embodiments, PoE or other power source may be utilized.

As illustrated in FIG. 4C, the remote communications device 306 is a network-connectivity extension, primarily for EV charging or solar monitoring locations where ZigBee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via ZigBee, Bluetooth, and the like. The power supply(ies) 432 may include a power interface for providing power to the remote communications device 306.

### Example Cloud Environment

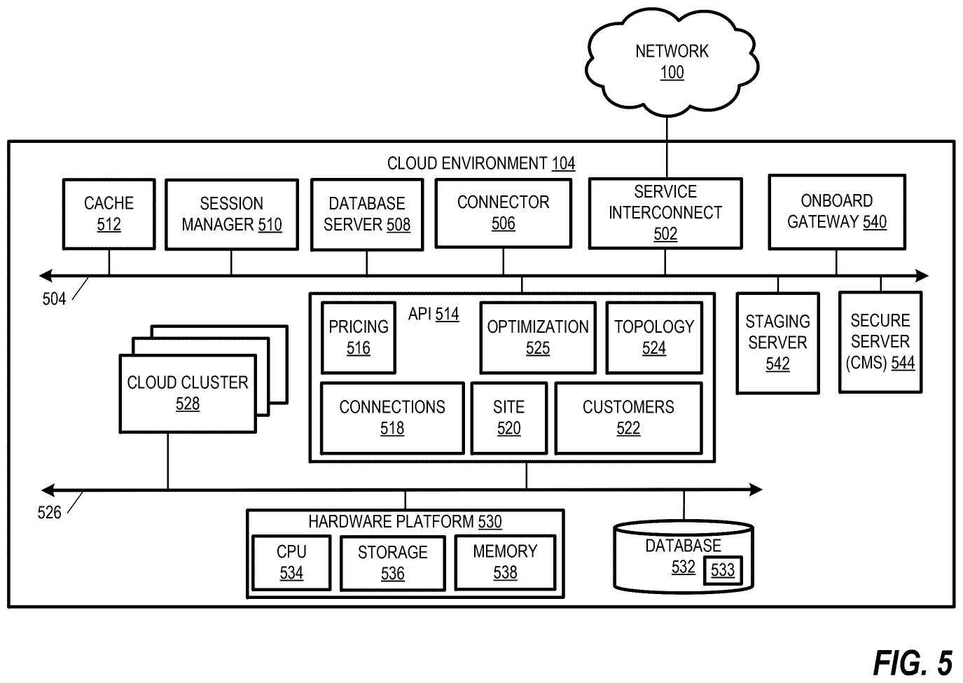

FIG. 5 depicts a device configuration for a cloud environment for managing electric vehicle charging, according to embodiments provided herein. As illustrated, the network 100 may couple to the cloud environment 104 via a service interconnect 502 that corresponds with the service interconnect 224 from FIG. 2 Similar to the service interconnect 224 from FIG. 2 the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an EVSE, such as charging station 112, for the exchange of data between the cloud environment 104 and the EVSE. For example, in some such embodiments, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, an onboard gateway 540, a staging server 542, a secure server (e.g., central management system) 544, and a collection of services and application programming interfaces (APIs) 514. The APIs 514 may include a pricing API 516, a connections API 518, a site API 520, a customers A PI 522, a topology API 524, and/or an optimization API 525. The APIs 514 may be implemented by the hardware platform 530. A hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections A PI 518, the site API 520, the customers API 522, the topology API 524, and/or the optimization API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EV SE(s), for example, related to payment for energy usage. In some embodiments, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain embodiments, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some embodiments, the optimization API 525 may be responsible for handling optimization requests, performing one or more optimization methods, and communicating the result of the optimization. For example, the optimization API 525 may be or include a service that may be executed when there is a newly connected or disconnected EVSE, such that an optimization may be performed to allocate (e.g., re-allocate) power according to updated state(s) of the EVSE(s).

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain embodiments, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

Moreover, as described further herein, the onboard gateway 540 may (similar to the edge gateway 202 shown in and described herein with respect to FIG. 2) perform onboarding techniques, such as described herein with reference to onboard gateway 602 of FIG. 6

### Device Configuration for Onboard Gateway System

FIG. 6 depicts a device configuration for an onboard system for managing electric vehicle charging, according to embodiments provided herein. The onboarding system includes an onboard gateway 602 (e.g., edge gateway 202 of FIG. 2 onboard gateway 540 of FIG. 5, etc.), a staging server 604 (e.g., staging server 204 of FIG. 2 staging server 542 of FIG. 5, etc.), and a secure server (e.g., central management system) 606 (e.g., secure server 206 of FIG. 2 secure server 544 of FIG. 5, etc.).

The onboard gateway 602 is in data communication with the staging server 604 and the secure server 606. When the onboard gateway 602 receives a connection request (e.g., from an unknown EVSE 608 or a known EVSE 610), the onboard gateway 602 first determines whether the connection request can be routed to the secure server 606-that is, the secure central management system providing various charging services to charging stations such as the charging station 112 of FIG. 1 as disclosed herein. The connection request may be received in the form of one or more data packets (e.g., IP packets) or any other data structure as would be understood by one of ordinary skill in the art, and include at least an identifier of the requesting EVSE. For example, the identifier may be a Chargebox Identity (CBID) as may be designated by the OCPP standards. This identifier may be verified by the onboard gateway 602 to determine whether the EVSE associated with the identifier is allowed to connect to the secure server 606. For example, the onboard gateway 602 may determine whether the identifier is for an authorized EVSE allowed to connect to the secure server 606. For example, the onboard gateway 602 may determine whether the identifier can be found in a list of approved identifiers (e.g., a “allow” list of identifiers) or process the identifier as a key to compare against one or more keys accessible by the onboard gateway 602. If the identifier is found in the list of approved identifiers and/or matches one or more keys accessible by the onboard gateway 602, the EVSE associated with the identifier may be determined as allowed to connect to secure server 606. If the identifier is not found in the list of approved identifiers and/or does not match any keys accessible by the onboard gateway 602, the EVSE associated with the identifier may be determined as not allowed to connect to secure server 606.

In certain embodiments, the connection request may also include a key, separate from the identifier, to be utilized for the onboard gateway 602 to determine whether the EVSE associated with the connection request is allowed to connect to the secure server 606. For example, the onboard gateway 602 may determine whether the key matches one or more stored keys corresponding to authorized EVSEs. If the key matches one or more stored keys corresponding to authorized EVSEs, the EVSE associated with the identifier may be determined as allowed to connect to secure server 606. If the key does not match any stored keys corresponding to authorized EVSEs, the EVSE associated with the identifier may be determined as not allowed to connect to secure server 606. In certain embodiments, the key may be or include, for example, pre-shared key(s), device-specific key(s), password(s), and/or passphrase(s). In some cases, certain EVSEs may be blocked from being able to connect to the secure server 606 (and/or the staging server 604 in certain embodiments) by a gateway service (e.g., via a firewall) for accepting and/or denying connections from the certain EVSEs based on their information such as, for example, associated IP addresses.

If the connection request is determined to be from a known EVSE 610, as in the EVSE is determined to be allowed to connect to the secure server 606, the onboard gateway 602 may facilitate connection of the EVSE with the secure server 606. For example, the onboard gateway 602 may route the connection request or send data (e.g., EVSE data, such as EVSE identifier or other configuration parameters associated with the EVSE) related to the connection request to secure server 606 for processing and connection with known EVSE 610. Moreover, the onboard gateway 602 may send information (e.g., related to connecting to secure server 606) to known EVSE 610 to communicate directly with secure server 606, etc.

If the connection request is determined to be from an unknown EVSE 608, as in the EVSE is determined to not be allowed to connect to the secure server 606, the onboard gateway 602 may facilitate connection of the EVSE with the staging server 604 to onboard the EVSE. For example, the onboard gateway 602 may route the connection request or send data related to the connection request to staging server 604 for processing and connection with unknown EVSE 608. Moreover, the onboard gateway 602 may send information (e.g., related to connecting to staging server 604) to unknown EVSE 608 to communicate directly with staging server 604, etc.

The staging server 604 may be configured to be in one of at least two modes: (i) in an “add” mode, and (ii) not in the add mode. In the add mode, the staging server 604 may accept a connection (e.g., via a connection request) with the unknown EVSE 608 and perform operations to onboard the unknown EVSE 608, as further discussed herein, to authorize the EVSE. Such an EVSE may become a known EVSE, such that for subsequent connection requests from the EVSE to onboard gateway 602, the EVSE is determined to be allowed to connect to the secure server 606. In some cases, the staging server 604 may be configured to send data to the secure server 606, such as to facilitate connection of the EV SE to the secure server 606 based on the initial connection request. When not in the add mode, the staging server 604 may not accept a connection (e.g., via a connection request) with the unknown EVSE 608, and the unknown EVSE 608 may not be allowed to connect to secure server 606.

In certain embodiments, onboard gateway 602 may be configured to determine a mode of staging server 604, such as by requesting and receiving or pulling such information from staging server 604, or from staging server 604 sending or pushing such information to onboard gateway 602 (e.g., periodically, when a mode change occurs, etc.). In certain embodiments, onboard gateway 602 may only facilitate connection of the EVSE with the staging server 604 to onboard the EVSE when the staging server 604 is in the add mode, and may otherwise drop or refuse the connection request.

In certain embodiments, the staging server 604 may be put in the add mode by, e.g., an operator attempting to onboard an unknown EVSE 608 to be serviced by the central management system of the secure server 606. For example, the operator may connect (e.g., directly) to the staging server 604 via a user interface (e.g., a web user interface which may be available to a customer having the unknown EVSE 608 and attempting to onboard the unknown EVSE 608, or a device user interface which may be available to an operator of the staging server 604 who may receive an instruction (e.g., based on a customer request) to put the staging server 604 in the add mode). Such user interface may also receive an input to turn off the add mode on the staging server 604 once the onboarding process has been completed for the unknown EVSE 608. In some embodiments, similar access for turning on the add mode may be available through the onboard gateway 602, such that the onboard gateway 602 may receive the operator instruction to set the staging server 604 to be in the add mode. The onboard gateway 602 may be configured to then communicate with the staging server 604 (e.g., by sending a corresponding signal or request) to cause the staging server 604 to be in the add mode. Further, the staging server 604 may be configured with a timeout period for the add mode, such that the add mode is turned off even if not turned off by the operator, for added security. When the onboard gateway 602 determines that the staging server 604 is not in the add mode (e.g., based on a read of a status register or the like) when a connection request from an unknown EVSE 608 is received, the onboard gateway 602 may dismiss the connection request.

In some embodiments, the access to control the add mode on the staging server 604 (e.g., via the user interface to the staging server 604) may require a set of credentials from the customer or the operator (e.g., a username-and-password combination or other methods known in the art), such that the control of the add mode on the staging server 604 is available only to a registered or trusted group of users. In certain embodiments, the registered or trusted group of users (e.g., credentialed users) may have access to an API configured for controlling the add mode on the staging server 604. Such requirement of the credentials for the access to control the add mode on the staging server 604 may provide a security measure that prevents a connection request from an unknown device at an unexpected time from being sent to the staging server 604. Accordingly, as long as the staging server 604 is in the add mode, even a connection request from an EVSE with incorrect credential(s) may still be able to reach the staging server 604 to initiate, e.g., a provisioning process to provide a valid credential or the like to such EVSE. Moreover, in certain cases, each EVSE may be set with a unique credential (e.g., different from other credentials of other EVSEs) to achieve further enhanced security (e.g., more secure than having the same credential being set for multiple EVSEs).

In certain embodiments, the onboard gateway 602, the staging server 604, and the secure server 606 may be provided in a cloud-based setting (see, e.g., the onboard gateway 540, the staging server 542, and the secure server 544 depicted in FIG. 5) and/or in an on-site setting (see, e.g., the edge gateway 202, the staging server 204, and the secure server 206 depicted FIG. 2).

### Architecture and Logic for Onboard Gateway

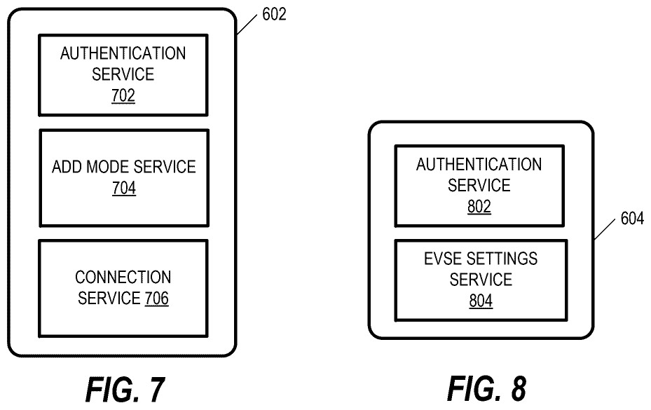

FIG. 7 depicts internal architecture and logic included within an onboard gateway, according to embodiments provided herein. As shown, the onboard gateway 602 of FIG. 6 may include an authentication service module 702, an add mode service module 704, and a connection service module 706. The authentication service module 702 may determine whether an incoming connection request to secure server 606 is for an EVSE allowed to connect to secure server 606. In that regard, the authentication service module 702 may implement one or more mechanisms to verify an identifier and/or a key associated with the EVSE initiating the incoming connection request. That is, the authentication service module 702 may be configured to, for example, access a list of approved identifiers or authenticate the received identifier or key.

The add mode service module 704 may be connected to a user interface for causing the staging server 604 to be in the add mode as disclosed herein, and may receive the instruction based on the input received via the user interface to cause the staging server 604 to be in the add mode. In some embodiments, the add mode service module 704 may be configured to cause the add mode of the staging server 604 to be turned off after a preset timeout period. Moreover, the add mode service module 704 may be configured to query and/or receive data from the staging server 604 to determine whether the staging server 604 is in the add mode.

The connection service module 706 may interact with the authentication service module 702 and/or the add mode service module 704. The connection service module 706 may interact with the authentication service module 702 to determine whether an incoming connection request to secure server 606 is for an EVSE allowed to connect to secure server 606 based on whether the EVSE identifier or a key associated with the EVSE may be authenticated by the authentication service module 702. Further, the connection service module 706 may interact with the add mode service module 704 to determine whether to facilitate an unknown EVSE to connect to the staging server 604 (if the staging server 604 is in the add mode), or to reject an incoming connection request from an unknown EVSE (if the staging server 604 is not in add mode).

### Architecture and Logic for Staging Service

FIG. 8 depicts internal architecture and logic included within a staging server, according to embodiments provided herein. As shown, the staging server 604 of FIG. 6 may include an authentication service module 802 and an EVSE settings service module 804.

The authentication service module 802 may authenticate an EVSE identifier of an unknown EVSE, such as based on data received from an onboard gateway that is based on an incoming connection request, by, for example: (1) adding the EVSE identifier to a list of known identifiers, (2) configuring the EV SE with a key, (3) configuring one or more settings of the EVSE, or the like. For example, the authentication service module 802 may be connected to a database (where, e.g., the list of known identifiers may be stored) to read the list of known identifiers therefrom and/or to write to the database to add an identifier to the list of approved identifiers.

The EVSE settings service module 804 may provide one or more settings to be updated on an EVSE. For example, the EVSE settings service module 804 may send a new key to be received by an EVSE such that the EVSE can subsequently connect to the secure server 606 with the new key to be verified by the onboard gateway 602. The EVSE settings service module 804 may send a new URL to be received by an EVSE such that the EVSE can subsequently connect to a new charging service system at a location associated with the new URL. For example, if a customer buys the hardware for a customer-site-specific charging management service to be installed at a charging site (e.g., in the edge environment 102 of FIG. 2), the EVSE which was connecting to, e.g., a cloud-based charging management service provided by a same service provider may be programmed to connect to the new charging management service available at a new location associated with the new URL (e.g., at the hardware for the customer-site-specific charging management service).

In another example, instead of configuring the EVSE with a new URL, a domain name system (DNS) server for the site of the EVSE may be configured to resolve the same URL to a different IP address, such as associated with a different onboard gateway.

### Data Structure for Connection Request

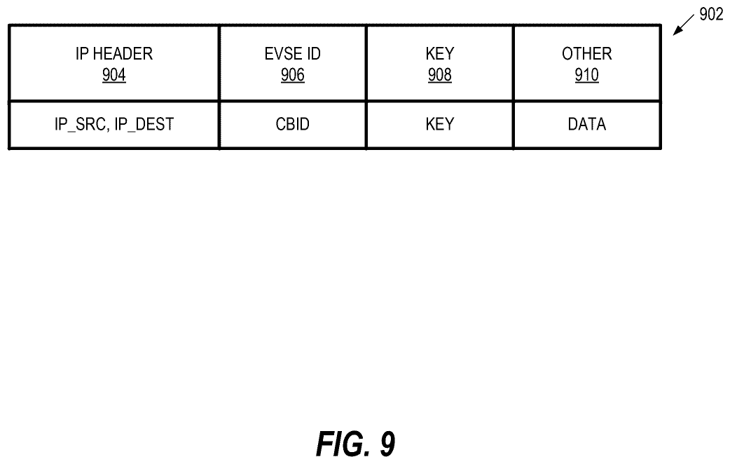

FIG. 9 depicts an example data structure for representing connection request parameters, according to embodiments provided herein. The data structure 902 can be used to represent technical connection request parameter values. This may include fields such as, but not limited to, an IP header 904 that can identify the source and destination addresses of the connection request, where the destination address may correspond to, for example, the IP address of the onboard gateway disclosed herein and where the source address may correspond to, for example, the IP address of the EVSE; an EVSE ID 906 that uniquely identifies the requesting EVSE, including but not limited to, for example, a Chargebox Identity (CBID); a key 908 that may be utilized for authenticating the requesting EVSE; and/or other information 910 which may include information or other context about the EVSE or connection request. For example, the other information 910 may include, but not be limited to, additional identifying information such as, for example, a serial number, firmware and/or software version information, and other identifying or location information such as, for example, Global Positioning System (GPS) coordinates.

### Protocol Sequence for EVSE and DNS

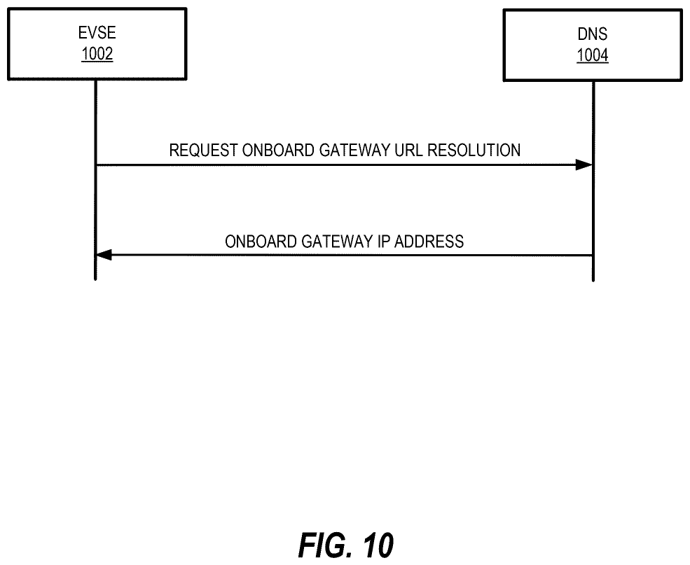

FIG. 10 depicts an example protocol sequence diagram for representing communication between an EVSE and a DNS server, according to embodiments provided herein. The DNS server 1004 may be available as a local DNS server available within, for example, the edge environment 102 of FIG. 1 in some embodiments.

As shown, the EVSE 1002 may send to the DNS server 1004 a request to resolve a URL for an onboard gateway. The DNS server 1004 may then return to the EVSE 1002 the IP address of the onboard gateway which can be utilized for the connection request. As discussed, in some embodiments, the IP address to which the URL resolves can be updated at the DNS server 1004, such as to allow the EVSE to connect to a different onboard gateway, without requiring reconfiguration of the EVSE.

### Process for Onboarding EVSE

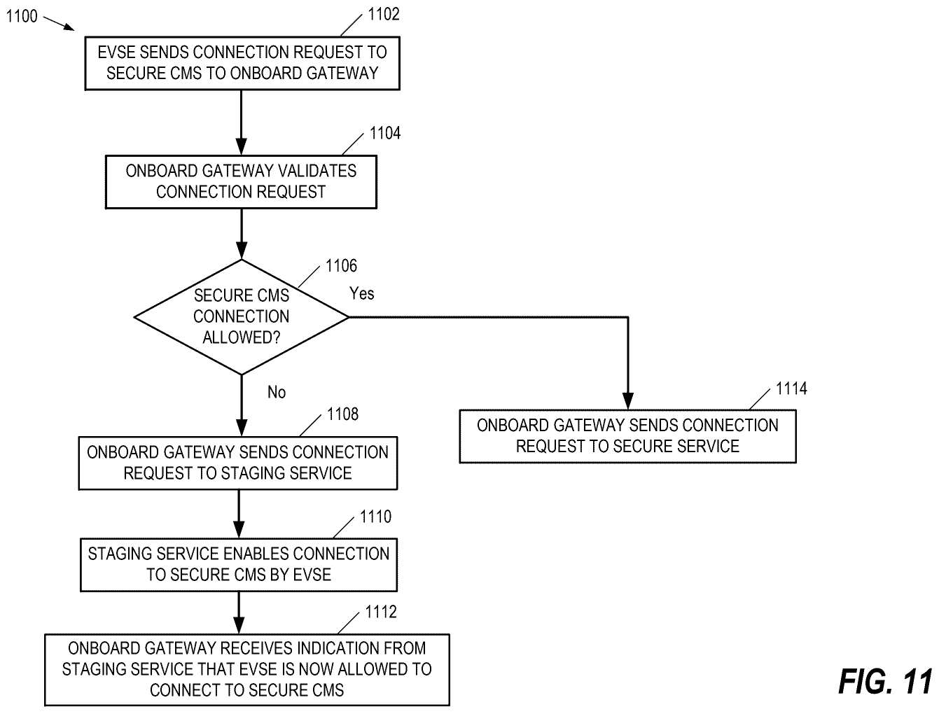

FIG. 11 depicts an example flowchart illustrating a method for managing electric vehicle charging-particularly for handling a connection request from an EVSE, according to embodiments provided herein. The method 1100 may be performed by one or more of the components shown in, e.g., FIG. 6.

In step 1102, an EVSE (e.g., an unknown EVSE 608 or a known EVSE 610) sends a connection request (to connect to a secure central management system) to an onboard gateway (such as the onboard gateway 602). The destination of the connection request may be configured based on a URL known to or configured at the requesting EVSE. As disclosed herein, the destination URL of the connection request may be resolved by a DNS server to identify the destination location (e.g., the IP address of the onboard gateway 602).

In step 1104, the onboard gateway 602 validates the connection request by, e.g., verifying an EVSE identifier (e.g., a CBID) and/or a key included in the connection request.

In step 1106, the onboard gateway 602 determines whether the requesting EVSE is allowed to connect to the secure central management system.

If the requesting EVSE is not allowed to connect to the secure central management system based on its identifier and/or key, the onboard gateway 602 may facilitate connection of the requesting EVSE with a staging service to onboard the requesting EVSE, in step 1108. For example, the onboard gateway 602 may route the connection request or send data related to the connection request to the staging service, such as staging server 604, for processing and connection with the requesting EVSE. The onboard gateway 602 may additionally or alternatively send information to the requesting EVSE to communicate directly with the staging service, etc. As disclosed herein, in some embodiments, the onboard gateway 602 may be configured to determine a mode of the staging service, such as by requesting and receiving or pulling such information from the staging service, or from the staging service sending or pushing such information to the onboard gateway 602 (e.g., periodically, when a mode change occurs, etc.). In certain embodiments, the onboard gateway 602 may only facilitate connection of the requesting EVSE with the staging service to onboard the requesting EVSE when the staging service is in an add mode, and may otherwise drop or refuse the connection request.

If the requesting EVSE is allowed to connect to the secure central management system based on its identifier and/or key, the onboard gateway 602 may facilitate connection of the requesting EVSE with the secure central management system, in step 1114. For example, the onboard gateway 602 may route the connection request or send data related to the connection request to the secure central management system for processing and connection with the requesting EVSE. Additionally or alternatively, the onboard gateway 602 may send information to the requesting EV SE to communicate directly with the secure central management system, etc.

In step 1110, once the connection request is sent to the staging service in step 1108, the staging service enables the requesting EVSE to connect to the secure central management system, such as by any of the various methods disclosed herein-for example, by adding the identifier of the requesting EV SE to a list of approved identifiers and/or authenticating the key included in the connection request. In some embodiments, the staging service may provide a key or the like to the requesting EVSE such that any subsequent connection request from the requesting EVSE may be sent to the secure central management system via the onboard gateway 602.

Once the connection to the secure central management system by the requesting EV SE has been enabled in step 1110, the onboard gateway 602 may receive from the staging service an indication (e.g., an acknowledgment message) that the requesting EVSE is allowed to connect to the secure central management system, in step 1112. Subsequent connection requests from such requesting EV SE may then be received by the onboard gateway 602 and sent to the secure central management system in a similar manner as described herein for step 1114.

### Example Processing System for Managing Electric Vehicle Charging

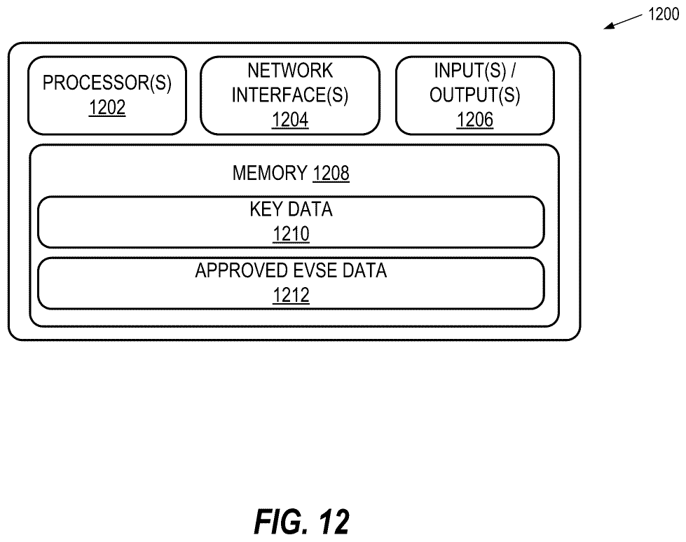

FIG. 12 depicts an example processing system for managing electric vehicle charging, according to embodiments provided herein. In various embodiments, processing system 1200 shown in FIG. 12 may be implemented on, for example, the onboard gateway 602 of FIG. 6.

As shown, the processing system 1200 may include one or more processors 1202. Generally, the one or more processors 1202 may be configured to execute computer-executable instructions (e.g., software code) to perform various functions, as described herein.

The processing system 1200 may further include one or more network interfaces 1204, which generally provide data access to any sort of data network, including personal area networks (PANs), local area networks (LANs), wide area networks (WANs), the internet, and the like.

Moreover, the processing system 1200 may include input(s) and output(s) 1206, which generally provide means for providing data to and from the processing system 1200, such as via connection to computing device peripherals, including user interface peripherals.

The processing system 1200 may also include one or more memories 1208 comprising various components. In this example, the one or more memories 1208 may include key data 1210 (e.g., including a key, such as a pre-shared key to be utilized for validating an EVSE) and/or approved EVSE data 1212 (e.g., including a list of approved identifiers for validating an EVSE).

The processing system 1200 may be implemented in various ways. For example, the processing system 1200 may be implemented as a computing device 402 within a core device 302, described herein with respect to FIGS. 3 and 4. In various embodiments, one or more aspects may be omitted from, added to, or substituted from the processing system 1200.

### Example Clauses

Implementation examples are described in the following numbered clauses:

Clause 1: A processing system for electric vehicle charging management, comprising: one or more memories; and one or more processors, coupled to the one or more memories, configured to cause the processing system to: receive one or more packets comprising a first request from a first electric vehicle supply equipment (EVSE) to connect to a central management system, wherein: the first request from the first EVSE comprises a first identifier associated with the first EVSE, and the one or more packets further comprise an Internet Protocol (IP) address associated with a Uniform Resource Locator (URL); determine whether the first EVSE is allowed to connect to the central management system based on the first identifier; and send first data related to the first request from the first EVSE to a staging service based on a determination that the first EVSE is not allowed to connect to the central management system based on the first identifier.

Clause 2: The processing system in accordance with clause 1, wherein: the first request from the first EVSE further comprises a key, and to determine whether the first EVSE is allowed to connect to the central management system comprises to determine whether the key matches a stored key stored in the one or more memories.

Clause 3: The processing system in accordance with any one of clauses 1-2, wherein: the first EVSE is Open Charge Point Protocol (OCPP)-compliant, and the central management system is OCPP-compliant.

Clause 4: The processing system in accordance with any one of clauses 1-3, wherein to determine whether the first EVSE is allowed to connect to the central management system comprises to determine whether the first identifier associated with the first EVSE is included in a list of approved identifiers.

Clause 5: The processing system in accordance with any one of clauses 1-4, wherein the one or more processors are further configured to cause the processing system to determine whether the staging service is in an add mode, wherein the staging service, when in the add mode, is configured to accept a request from an unknown EVSE associated with an unknown identifier.

Clause 6: The processing system in accordance with clause 5, wherein the one or more processors are further configured to cause the processing system to: receive one or more additional packets comprising a second request from a second EVSE to connect to the central management system, wherein: the second request from the second EVSE comprises a second identifier associated with the second EVSE, and the one or more additional packets further comprise the IP address associated with the URL; determine whether the second EVSE is allowed to connect to the central management system based on the second identifier; and deny the second request from the second EVSE based on a determination that the staging service is not in the add mode and that the second EVSE is not allowed to connect to the central management system based on the second identifier.

Clause 7: The processing system in accordance with any one of clauses 5-6, wherein to send the first data related to the first request from the first EVSE to the staging service is further based on a determination that the staging service is in the add mode.

Clause 8: The processing system in accordance with any one of clauses 1-7, wherein the processing system is implemented as a cloud-based service.

Clause 9: The processing system in accordance with any one of clauses 1-7, wherein the processing system is implemented as an on-site service implemented at a customer site.

Clause 10: The processing system in accordance with any one of clauses 1-9, wherein the one or more processors are further configured to cause the processing system to change one or more settings on the first EVSE by the staging service.

Clause 11: The processing system in accordance with clause 10, wherein the one or more settings comprise one or more of: a key; or the URL.

Clause 12: The processing system in accordance with any one of clauses 10-11, wherein: to change the one or more settings on the first EVSE by the staging service comprises to change the one or more settings on the first EVSE such that the first EVSE is enabled to connect to the central management system based on the changed one or more settings, and the one or more processors are further configured to cause the processing system to receive data indicating that the first EVSE is allowed to connect to the central management system based on the changed one or more settings.

Clause 13: The processing system in accordance with clause 12, wherein the one or more processors are further configured to cause the processing system to: receive one or more additional packets comprising a second request from the first EVSE to connect to the central management system, wherein the second request from the first EVSE comprises the changed one or more settings; determine that the first EVSE is allowed to connect to the central management system based on the changed one or more settings; and send second data related to the second request from the first EVSE to the central management system based on a determination that the first EVSE is allowed to connect to the central management system based on the changed one or more settings.

Clause 14: The processing system in accordance with any one of clauses 1-13, wherein the one or more processors are further configured to cause the processing system to: receive one or more additional packets comprising a second request from a second EVSE to connect to the central management system, wherein: the second request from the second EVSE comprises a second identifier associated with the second EVSE, and the one or more additional packets further comprise the IP address associated with the URL; determine whether the second EVSE is allowed to connect to the central management system based on the second identifier; and send second data related to the second request from the second EV SE to the central management system based on a determination that the second EVSE is allowed to connect to the central management system based on the second identifier.

Clause 15: The processing system in accordance with any one of clauses 1-14, wherein the one or more processors are further configured to cause the processing system to: authorize, by the staging service, the first identifier; receive one or more additional packets comprising a second request from the first EVSE to connect to the central management system, wherein the second request from the first EVSE comprises the first identifier associated with the first EVSE; determine that the first EVSE is allowed to connect to the central management system based on the first identifier associated with the first EVSE being authorized; and send second data related to the second request from the first EVSE to the central management system based on a determination that the first EVSE is allowed to connect to the central management system based on the first identifier associated with the first EVSE being authorized.

Clause 16: A method for electric vehicle charging management, comprising: receiving one or more packets comprising a first request from a first electric vehicle supply equipment (EVSE) to connect to a central management system, wherein: the first request from the first EVSE comprises a first identifier associated with the first EVSE, and the one or more packets further comprise an Internet Protocol (IP) address associated with a Uniform Resource Locator (URL); determining whether the first EVSE is allowed to connect to the central management system based on the first identifier; and sending first data related to the first request from the first EVSE to a staging service based on determining that the first EVSE is not allowed to connect to the central management system based on the first identifier.

Clause 17: The method in accordance with clause 16, wherein: the first request from the first EVSE further comprises a key, and determining whether the first EVSE is allowed to connect to the central management system comprises determining whether the key matches a stored key stored in one or more memories.

Clause 18: The method in accordance with any one of clauses 16-17, wherein the first EVSE is Open Charge Point Protocol (OCPP)-compliant; and the central management system is OCPP-compliant.

Clause 19: The method in accordance with any one of clauses 16-18, wherein determining whether the first EVSE is allowed to connect to the central management system comprises determining whether the first identifier associated with the first EVSE is included in a list of approved identifiers.

Clause 20: The method in accordance with any one of clauses 16-19, further comprising determining whether the staging service is in an add mode, wherein the staging service, when in the add mode, is configured to accept a request from an unknown EVSE associated with an unknown identifier.

Clause 21: The method in accordance with clause 20, further comprising: receiving one or more additional packets comprising a second request from a second EVSE to connect to the central management system, wherein: the second request from the second EVSE comprises a second identifier associated with the second EVSE, and the one or more additional packets further comprise the IP address associated with the URL; determining whether the second EVSE is allowed to connect to the central management system based on the second identifier; and denying the second request from the second EVSE based on determining that the staging service is not in the add mode and that the second EVSE is not allowed to connect to the central management system based on the second identifier.

Clause 22: The method in accordance with any one of clauses 20-21, wherein sending the first data related to the first request from the first EVSE to the staging service is further based on determining that the staging service is in the add mode.

Clause 23: The method in accordance with any one of clauses 16-22, wherein the method is implemented as a cloud-based service.

Clause 24: The method in accordance with any one of clauses 16-22, wherein the method is implemented as an on-site service implemented at a customer site.

Clause 25: The method in accordance with any one of clauses 16-24, further comprising changing one or more settings on the first EVSE by the staging service.

Clause 26: The method in accordance with clause 25, wherein the one or more settings comprise one or more of: a key; or the URL.

Clause 27: The method in accordance with any one of clauses 25-26, wherein changing the one or more settings on the first EVSE by the staging service comprises changing the one or more settings on the first EVSE such that the first EVSE is enabled to connect to the central management system based on the changed one or more settings; and the method further comprises receiving data indicating that the first EVSE is allowed to connect to the central management system based on the changed one or more settings.

Clause 28: The method in accordance with any one of clauses 25-27, further comprising: receiving one or more additional packets comprising a second request from the first EVSE to connect to the central management system, wherein the second request from the first EVSE comprises the changed one or more settings; determining that the first EVSE is allowed to connect to the central management system based on the changed one or more settings; and sending second data related to the second request from the first EVSE to the central management system based on determining that the first EVSE is allowed to connect to the central management system based on the changed one or more settings.

Clause 29: The method in accordance with any one of clauses 16-28, further comprising: receiving one or more additional packets comprising a second request from a second EVSE to connect to the central management system, wherein: the second request from the second EVSE comprises a second identifier associated with the second EVSE, and the one or more additional packets further comprise the IP address associated with the URL; determining whether the second EVSE is allowed to connect to the central management system based on the second identifier; and sending second data related to the second request from the second EVSE to the central management system based on determining that the second EVSE is allowed to connect to the central management system based on the second identifier.

Clause 30: The method in accordance with any one of clauses 16-29, further comprising: authorizing, by the staging service, the first identifier; receiving one or more additional packets comprising a second request from the first EVSE to connect to the central management system, wherein the second request from the first EVSE comprises the first identifier associated with the first EVSE; determining that the first EVSE is allowed to connect to the central management system based on the first identifier associated with the first EVSE being authorized; and sending second data related to the second request from the first EVSE to the central management system based on determining that the first EVSE is allowed to connect to the central management system based on the first identifier associated with the first EVSE being authorized.

Clause 31: A system for electric vehicle charging management, comprising: an onboard gateway device comprising one or more processors configured to perform the steps of any one of clauses 16-30; and a staging service device in data communication with the onboard gateway device, comprising one or more processors configured to implement the staging service; and authorize the first identifier associated with the first EVSE.

Clause 32: A processing system, comprising: one or more memories comprising computer-executable instructions; and one or more processors configured to execute the computer-executable instructions and cause the processing system to perform a method in accordance with any one of clauses 16-30.

Clause 33: A processing system, comprising means for performing a method in accordance with any one of clauses 16-30.

Clause 34: A non-transitory computer-readable medium storing program code for causing a processing system to perform the steps of any one of clauses 16-30.

Clause 35: A computer program product embodied on a computer-readable storage medium comprising code for performing a method in accordance with any one of clauses 16-30.

Clause 36: A processing system, comprising: one or more memories; and one or more processors, coupled to the one or more memories, configured to cause the processing system to perform a method in accordance with any one of clauses 16-30.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums corresponding to, for example, an onboard gateway for management of electric vehicle (EV) charging. It should also be understood that these embodiments are merely exemplary and are not intended to limit the scope of this disclosure.

What is claimed is:

1. A processing system for electric vehicle charging management, comprising: one or more memories; and one or more processors, coupled to the one or more memories, configured to cause the processing system to:
receive one or more packets comprising a first request from a first electric vehicle supply equipment (EVSE) to connect to a central management system, wherein:
the first request from the first EVSE comprises a first identifier associated with the first EVSE, and
the one or more packets further comprise an Internet Protocol (IP) address associated with a Uniform Resource Locator (URL);
determine whether the first EVSE is allowed to connect to the central management system based on the first identifier; and
send first data related to the first request from the first EVSE to a staging service based on a determination that the first EVSE is not allowed to connect to the central management system based on the first identifier.

2. The processing system of claim 1, wherein:
the first request from the first EVSE further comprises a key, and
to determine whether the first EVSE is allowed to connect to the central management system comprises to determine whether the key matches a stored key stored in the one or more memories.

3. The processing system of claim 1, wherein:
the first EVSE is Open Charge Point Protocol (OCPP)-compliant, and
the central management system is OCPP-compliant.

4. The processing system of claim 1, wherein to determine whether the first EVSE is allowed to connect to the central management system comprises to determine whether the first identifier associated with the first EVSE is included in a list of approved identifiers.

5. The processing system of claim 1, wherein the one or more processors are further configured to cause the processing system to determine whether the staging service is in an add mode, wherein the staging service, when in the add mode, is configured to accept a request from an unknown EVSE associated with an unknown identifier.

6. The processing system of claim 5, wherein the one or more processors are further configured to cause the processing system to:
receive one or more additional packets comprising a second request from a second EVSE to connect to the central management system, wherein:
the second request from the second EVSE comprises a second identifier associated with the second EVSE, and
the one or more additional packets further comprise the IP address associated with the URL;
determine whether the second EVSE is allowed to connect to the central management system based on the second identifier; and
deny the second request from the second EVSE based on a determination that the staging service is not in the add mode and that the second EVSE is not allowed to connect to the central management system based on the second identifier.

7. The processing system of claim 5, wherein to send the first data related to the first request from the first EVSE to the staging service is further based on a determination that the staging service is in the add mode.

8. The processing system of claim 1, wherein the processing system is implemented as a cloud-based service.

9. The processing system of claim 1, wherein the processing system is implemented as an on-site service implemented at a customer site.

10. The processing system of claim 1, wherein the one or more processors are further configured to cause the processing system to change one or more settings on the first EVSE by the staging service.

11. The processing system of claim 10, wherein the one or more settings comprise one or more of:
a key; or
the URL.

12. The processing system of claim 10, wherein:
to change the one or more settings on the first EVSE by the staging service comprises to change the one or more settings on the first EVSE such that the first EVSE is enabled to connect to the central management system based on the changed one or more settings, and
the one or more processors are further configured to cause the processing system to receive data indicating that the first EVSE is allowed to connect to the central management system based on the changed one or more settings.

13. The processing system of claim 12, wherein the one or more processors are further configured to cause the processing system to:
receive one or more additional packets comprising a second request from the first EVSE to connect to the central management system, wherein the second request from the first EVSE comprises the changed one or more settings;
determine that the first EVSE is allowed to connect to the central management system based on the changed one or more settings; and
send second data related to the second request from the first EVSE to the central management system based on a determination that the first EVSE is allowed to connect to the central management system based on the changed one or more settings.

14. The processing system of claim 1, wherein the one or more processors are further configured to cause the processing system to:
receive one or more additional packets comprising a second request from a second EVSE to connect to the central management system, wherein:
the second request from the second EVSE comprises a second identifier associated with the second EVSE, and
the one or more additional packets further comprise the IP address associated with the URL;
determine whether the second EVSE is allowed to connect to the central management system based on the second identifier; and
send second data related to the second request from the second EVSE to the central management system based on a determination that the second EVSE is allowed to connect to the central management system based on the second identifier.

15. The processing system of claim 1, wherein the one or more processors are further configured to cause the processing system to:
authorize, by the staging service, the first identifier;
receive one or more additional packets comprising a second request from the first EVSE to connect to the central management system, wherein the second request from the first EVSE comprises the first identifier associated with the first EVSE;
determine that the first EVSE is allowed to connect to the central management system based on the first identifier associated with the first EVSE being authorized; and
send second data related to the second request from the first EVSE to the central management system based on a determination that the first EVSE is allowed to connect to the central management system based on the first identifier associated with the first EVSE being authorized.

16. A method for electric vehicle charging management, comprising:
receiving one or more packets comprising a first request from a first electric vehicle supply equipment (EVSE) to connect to a central management system, wherein:
the first request from the first EVSE comprises a first identifier associated with the first EVSE, and
the one or more packets further comprise an Internet Protocol (IP) address associated with a Uniform Resource Locator (URL);
determining whether the first EVSE is allowed to connect to the central management system based on the first identifier; and
sending first data related to the first request from the first EVSE to a staging service based on determining that the first EVSE is not allowed to connect to the central management system based on the first identifier.

17. The method of claim 16, wherein:
the first request from the first EVSE further comprises a key, and
determining whether the first EVSE is allowed to connect to the central management system comprises determining whether the key matches a stored key stored in one or more memories.

18. The method of claim 16, wherein determining whether the first EVSE is allowed to connect to the central management system comprises determining whether the first identifier associated with the first EVSE is included in a list of approved identifiers.

19. A system for electric vehicle charging management, comprising:
a staging service device comprising one or more processors configured to authorize a first identifier associated with a first electric vehicle supply equipment (EVSE); and
an onboard gateway device in data communication with the staging service device, comprising one or more processors configured to:
receive one or more packets comprising a first request from the first EVSE to connect to a central management system, wherein:
the first request from the first EVSE comprises the first identifier associated with the first EVSE, and
the one or more packets further comprise an Internet Protocol (IP) address associated with a Uniform Resource Locator (URL);
determine whether the first EVSE is allowed to connect to the central management system based on the first identifier; and
send first data related to the first request from the first EVSE to the staging service device based on a determination that the first EVSE is not allowed to connect to the central management system based on the first identifier.

20. The system of claim 19, wherein to authorize the first identifier associated with the first EVSE comprises to verify a key associated with the first EVSE against a stored key stored in one or more memories coupled to the one or more processors on the staging service device.
